(19) United States
(12) Patent Application Publication
(10) Pub. No.: US 2020/0208777 A1
(43) Pub. Date: Jul. 2, 2020

(54) Liquid oxygen storage tank

(71) Applicant: Gongping He, Shanghai City (CN)

(72) Inventor: Gongping He, Shanghai City (CN)

(21) Appl. No.: 16/816,290

(22) Filed: Mar. 12, 2020

(30) Foreign Application Priority Data
Dec. 6, 2019 (CN) 2019112425664

(51) Int. Cl. F17C 1/12; F17C 13/04

(52) U.S. Cl. CPC F17C 1/12; F17C 13/04; F17C 2221/011; F17C 2260/021; F17C 2203/03; F17C 2250/043; F17C 2201/0109

(57) ABSTRACT

The invention discloses a liquid oxygen storage tank, which includes an outer tank body, a buffer cavity is provided in the outer tank body, and an insulation tank with an upper end extending outside the buffer cavity is provided in the buffer cavity, and the buffer chamber is provided in the buffer tank. There is a buffer mechanism for reducing the impact force of the tank body. The thermal insulation tank is internally provided with an internal tank body, the internal tank body is provided with a storage cavity, and the upper end of the thermal insulation tank is provided with a control cavity. A driving block is arranged in the cavity. The invention adopts a high-vacuum multi-layer thermal insulation technology to prolong the number of days for holding liquid oxygen, and a heat preservation mechanism makes the storage time of liquid oxygen longer, and it is safer and more convenient to operate. If it is too high, it will start automatically and discharge excess gas to enhance the safety of use. Protect the container from damage. Ordinary personnel can rest assured to use it without the guidance of professionals.

### CROSS-REFERENCES TO RELATED APPLICATIONS

The present application claims priority from Chinese application No. 2019112425664 filed on Sep. 19, 2019 which is hereby incorporated by reference in its entirety.

### TECHNICAL FIELD

The invention relates to the technical field of storage and transportation, in particular to a liquid oxygen storage tank.

### BACKGROUND OF THE INVENTION

Liquid oxygen has a wide range of industrial and medical uses. Due to its low temperature properties, liquid oxygen will make the materials it contacts become very brittle. Liquid oxygen is also a very strong oxidant: organic substances burn violently in liquid oxygen. When immersed in liquid oxygen for a period of time, an explosion may occur. At this stage, the shell portion of the liquid oxygen storage and transportation container is not thermally insulated, the liquid oxygen is stored for a few days, and the safety valve is not flexible to start and jump, and there are hidden safety problems.

### BRIEF SUMMARY OF THE INVENTION

The object of the present invention is to provide a liquid oxygen storage tank, which is used to overcome the above defects in the prior art.

A liquid oxygen storage tank according to the present invention comprises an outer tank body, wherein a buffer cavity is provided in the outer tank body, and an insulation tank with an upper end extending out of the buffer cavity is provided in the buffer chamber, and the buffer chamber is provided in the buffer tank. There is a buffer mechanism for reducing the impact force of the tank body. The thermal insulation tank is internally provided with an internal tank body, the internal tank body is provided with a storage cavity, and the upper end of the thermal insulation tank is provided with a control cavity. A transmission block is provided in the cavity. The transmission block is provided with a transmission cavity. The transmission cavity is threadedly connected with a downwardly extending transmission rod. A spring cavity is provided below the control cavity. A sealing mechanism for sealing the storage cavity, the sealing mechanism includes a piston block, a pressure relief block is fixed in the piston block, a pressure relief cavity is arranged in the pressure relief block, and the pressure relief cavity is provided in the pressure relief cavity. There is a pressure relief mechanism for maintaining the pressure in the tank. A tank joint is provided on the right side of the pressure relief chamber. An internal communication chamber is provided in the tank joint. A stopper is slidably arranged in the internal communication chamber. The right end of the plug is rotatably provided with a rotating rod, and the lower end of the rotating rod is rotated with the lower side wall of the inline communication cavity. Then, a cooling box is provided on the left side of the outer tank, and a cooling mechanism for cooling the storage chamber is provided in the cooling box. The cooling mechanism includes a cooling chamber provided in the cooling box. A compressor chamber is also provided in the box, and a compressor is fixed in the compressor chamber. A pump chamber is also provided in the cooling box, and a pump is fixed in the pump chamber.

On the basis of the above technical solution, a joint is installed on the tank joint, and a joint cavity is provided in the joint. An inner joint is provided in the joint cavity. An outer communication chamber is provided in the inner joint. A feed cavity is provided on the left side of the communication cavity. A sliding sleeve cavity is provided in the joint wall. A sliding sleeve is provided in the sliding sleeve cavity. A slider is fixed on the outer side of the sliding sleeve. A lower side of the sliding sleeve cavity is provided. The wall is provided with a fixing ring, and the fixing ring is slidably connected with a fixing bead.

Based on the above technical solution, the buffer mechanism further includes a buffer spring provided in the buffer cavity, one end of the buffer spring is fixedly connected to the inside of the outer tank body, and the other end of the buffer spring is connected to the heat insulation The outer surface of the tank is fixedly connected.

On the basis of the above technical solution, the cooling mechanism further includes a heat exchange plate provided in the cooling chamber, and a lower side wall of the compression chamber is fixed with a coolant pipe extending up and down, and the upper end of the coolant pipe and the The lower end of the fixed-fit connection of the compressor is connected to the heat exchange plate. A condensation tube is fixed to the left side wall of the compression chamber, and a capillary tube is fixed to the lower end of the condensation tube. The lower end of the capillary tube is connected to the heat exchange plate. A pump chamber is provided below the cooling chamber, and a pump is fixed in the pump chamber. A cooling pipe extending from left to right is fixed to the right wall of the pump chamber, and the cooling pipe extends to the right to The heat insulation tank body is connected to the heat exchange plate through the right side wall of the cooling chamber after surrounding the inner tank body from top to bottom, and the left side wall of the pump chamber is fixed with cooling pipes extending left and right, The left end of the cooling pipe is connected to the heat exchange plate.

On the basis of the above technical solution, the pressure relief mechanism includes a pressure relief slider disposed in the pressure relief chamber, a lower end of the pressure relief slider is fixedly provided with a pressure relief rod, and a lower end of the pressure relief rod is fixedly connected There is a sealing plug, the pressure relief slider is provided with a pressure relief hole, a pressure relief spring is fixedly connected to the upper end of the pressure relief slider, and the upper end of the pressure relief spring is fixedly connected to the upper side wall of the pressure relief cavity. A communicating air hole is provided between the spring cavity and the pressure relief cavity, and an air outlet hole communicating with the outside is provided on the left wall of the spring cavity.

The beneficial effects of the present invention are: adopting high-vacuum multi-layer insulation technology to prolong the number of days for holding liquid oxygen, having a heat preservation mechanism to make the storage time of liquid oxygen longer, safer and more convenient operation, and installing a pressure relief valve on the container body, the pressure is excessive, Automatic start-up, discharge excess gas, and enhance the safety of use. Protect the container from damage. Ordinary personnel can rest assured to use it without the guidance of professionals.

On the basis of the above technical solution, the sealing mechanism further includes the spring cavity. A piston spring is fixed in the spring cavity. The upper end of the piston spring is fixedly connected to the upper side wall of the spring cavity. The lower end of the piston spring It is fixedly connected with the upper end surface of the piston block.

### BRIEF DESCRIPTION OF THE DRAWINGS

In order to more clearly explain the embodiments of the present invention or the technical solutions in the prior art, the drawings used in the embodiments are briefly introduced below. Obviously, the drawings in the following description are just some of the present invention For those of ordinary skill in the art, other embodiments may be obtained based on these drawings without paying creative labor.

1 is a schematic diagram of the overall structure of a liquid oxygen storage tank according to the present invention;

FIG. 2 is an enlarged view of a partial structure in FIG. 1; FIG.

FIG. 3 is a schematic structural diagram at A in FIG. 1; FIG.

4 is a schematic diagram of the overall structure of the special joint of the present invention.

### DETAILED DESCRIPTION OF THE INVENTION

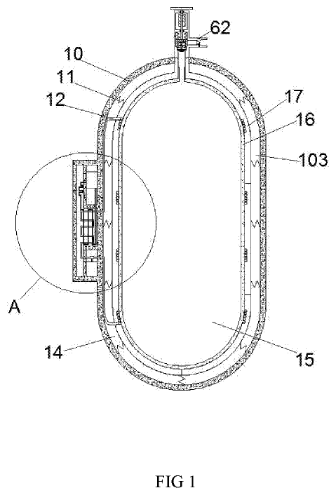

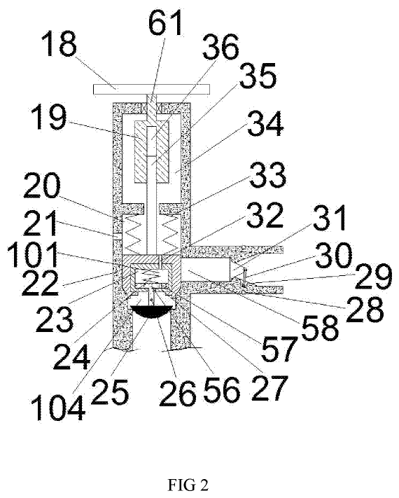

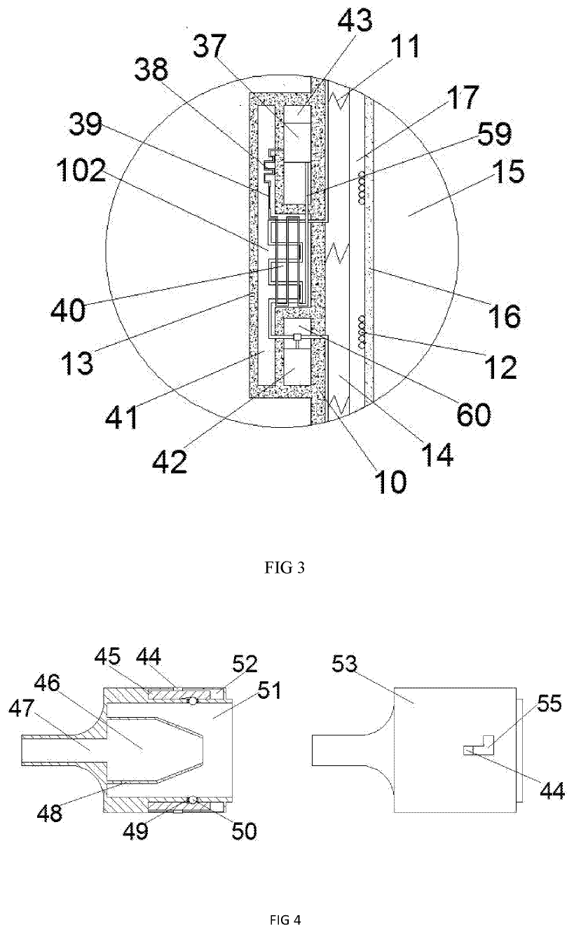

The present invention is described in detail below with reference to FIGS. 1-4. For convenience of description, the orientation described below is defined as follows: the up-down, left-right, front-back direction described below is consistent with the up-down, left-right, front-back direction of the projection relationship of FIG. 1 itself.

Referring to FIGS. 1-4, a liquid oxygen storage tank according to an embodiment of the present invention includes an outer tank body 10, which is provided with a buffer chamber 14 therein, and the upper end of the buffer chamber 14 extends to Insulation tank 17 outside buffer chamber 14, a buffer mechanism 103 is provided in the buffer chamber 14 to reduce the impact force of the tank body, and an inner tank body 16 is fixed in the heat insulation tank 17. A storage cavity 15 is provided in the body 16, and a control cavity 34 is provided on the upper end of the heat insulation tank 17. A transmission block 19 is provided in the control cavity 34, and a transmission cavity 36 is provided in the transmission block 19. 36, an internally threaded connection is provided with a transmission rod 35 extending downward. A spring chamber 20 is provided below the control chamber 34, and a sealing mechanism 104 for sealing the storage chamber 15 is provided in the spring chamber 20. The mechanism 104 includes a piston block 22 having a pressure relief block 27 fixed therein. The pressure relief block 27 is provided with a pressure relief chamber 23 therein. A pressure relief chamber 23 is provided in the pressure relief chamber 23 to maintain the pressure in the tank. Pressure mechanism 101, a tank joint 62 is provided on the right side of the pressure relief chamber 23, and an inner communication chamber 58 is provided in the tank joint 62, and a block is provided in the inner communication chamber 58 in a sliding manner. 31. The right end of the stopper 31 is rotatably provided with a rotation rod 30. The lower end of the rotation rod 30 is rotatably connected to the lower side wall of the inline communication cavity 58. The cooling tank 13 is fixedly connected to the left side of the outer tank 10. A cooling mechanism 102 for cooling the storage chamber 15 is provided in the cooling box. The cooling mechanism 102 includes a cooling chamber 41 provided in the cooling box 13. A compressor chamber 43 is also provided in the cooling box 13. A compressor 37 is fixed in the compressor chamber 43, and a pumping chamber 60 is also provided in the cooling box 13, and a pump 42 is fixed in the pumping chamber 60.

In addition, in one embodiment, a joint 53 is installed on the tank joint 62, and a joint cavity 51 is provided in the joint 53. The joint cavity 51 is provided with an inner joint 48 therein, and the inner joint 48 is provided therein. There is an external communication cavity 46. The external communication cavity 46 is provided with an inlet and outlet cavity 47 on the left side, a sliding sleeve cavity 52 is provided in the wall of the joint 53, and a sliding sleeve 45 is provided in the sliding sleeve cavity 52. A slider 44 is fixed on the outer side of the sleeve, and a fixing ring 49 is provided on the lower side wall of the sliding sleeve cavity 52, and the fixing ring 49 is slidably connected with a fixing bead 50.

In addition, in an embodiment, the buffer mechanism 103 further includes a buffer spring 11 disposed in the buffer cavity 14. One end of the buffer spring 11 is fixedly connected to the inside of the outer tank 10. The buffer spring 11 The other end is fixedly connected to the outer surface of the heat insulation tank 17; when a collision occurs, the impact force is buffered by the outer tank 10 and then buffered by the buffer spring 11.

In addition, in one embodiment, the cooling mechanism 102 further includes a heat exchange plate 40 disposed in the cooling cavity 41, and a lower side wall of the compression cavity 43 is fixed with a coolant pipe 59 extending vertically. The upper end of the coolant pipe 59 is fixedly fitted to the compressor 43 and the lower end is connected to the heat exchange plate 40. A left side wall of the compression chamber 43 is provided with a condenser tube 38, and a lower end of the condenser tube 38 is provided with a capillary tube. 39. The lower end of the capillary 39 is connected to the heat exchange plate 40. A pump chamber 60 is provided below the cooling chamber 41, and a pump 42 is fixed in the pump chamber 60. The right side of the pump chamber 60 is The wall is provided with cooling pipes 12 extending left and right. The cooling pipes 12 extend to the right into the insulated tank 17 and surround the inner tank 16 from top to bottom and pass through the right wall of the cooling cavity 41. Connected to the heat exchange plate, the left side wall of the pump cavity 60 is provided with cooling pipes 12 extending left and right, and the left end of the cooling pipe 12 is connected to the heat exchange plate 40; The cooling liquid enters the cooling pipe 12 from the upper end of the heat exchange plate 40, and circulates in the cooling pipe 12 Then, it returns to the heat exchange plate 40 again. When the compressor 37 is in operation, the coolant is delivered from the coolant pipe 59 fixed on the lower side wall of the compressor cavity 43 into the heat exchange plate 40. After returning to the coolant pipe 59 through the capillary tube 39 and the condensation pipe 38, heat will be transferred from the cooling pipe 12 to the coolant pipe 12, and then transferred to the outside by the condenser 38, So as to achieve the cooling function of the inner tank 16.

In addition, in one embodiment, the sealing mechanism 104 further includes the spring cavity 20. A piston spring 33 is fixed in the spring cavity 20. The upper end of the piston spring 33 is fixed to the upper side wall of the spring cavity 20. The lower end of the piston spring 33 is fixedly connected to the upper end surface of the piston block 22.

In addition, in one embodiment, the pressure relief mechanism 101 includes a pressure relief slider 56 disposed in the pressure relief cavity 23, and a pressure relief rod 26 is fixedly connected to a lower end of the pressure relief slider 56. A sealing plug 25 is fixedly connected to the lower end of the pressure relief rod 26, and a pressure relief hole 27 is opened in the pressure relief slider 56. A pressure relief spring 24 is fixedly connected to the upper end of the pressure relief slider 56. The upper side wall of the pressure relief chamber 23 is fixedly connected, a communication air guide hole 32 is provided between the spring chamber 20 and the pressure relief chamber 23, and a left side wall of the spring chamber 20 is provided with an air outlet hole 21 that communicates with the outside world. When the pressure in the storage chamber 15 is higher than the limited pressure, the piston 25 is compressed, the sealing plug 25 is jacked up by air pressure, and the sealing plug 25 drives the pressure relief rod 26 to move upward, and the pressure is released. The pressure rod 26 drives the pressure relief slider 56 to move the gas upward through the pressure relief hole 57 into the pressure relief cavity 24, and then enters the spring cavity 20 through the air guide hole 32, and then passes through the outlet The air holes 21 are discharged, so as to keep the pressure in the storage chamber 15 stable.

In the initial state, the pressure relief spring 24 and the piston spring 33 are in an uncompressed state.

When the temperature needs to be lowered, the compressor 37 and the pump 42 start to work, and the cooling liquid and the coolant exchange heat in the heat exchange plate 40 so as to keep the liquid oxygen in the storage chamber 15 warm.

When pressure relief is required, the sealing plug 25 drives the pressure relief lever 26 to move upward, and the pressure relief lever 26 drives the pressure relief slider 56 to move the gas upward through the pressure relief hole 57 into the pressure relief In the cavity 24, the air enters the spring cavity 20 through the air guide hole 32, and then exits through the air outlet hole 21, so as to maintain the pressure in the storage cavity 15 stable.

When charging and discharging is required, the rotary disk 18 is rotated, and the sealing plug 25 moves upwards. At this time, the gas passes into the internal communication cavity 58 and then enters the external communication cavity 46 to achieve charging. Deflation function.

The beneficial effects of the present invention are: adopting high-vacuum multi-layer insulation technology to prolong the number of days for holding liquid oxygen, having a heat preservation mechanism to make the storage time of liquid oxygen longer, safer and more convenient operation, and installing a pressure relief valve on the container body, the pressure is excessive, Automatic start-up, discharge excess gas, and enhance the safety of use. Protect the container from damage. Ordinary personnel can rest assured to use it without the guidance of professionals.

The above are only preferred embodiments of the present invention, and are not intended to limit the present invention. Any modification, equivalent replacement, or improvement made within the spirit and principle of the present invention shall be included in the present invention. Within the scope of protection.

1. A liquid oxygen storage tank includes an outer tank body, which is characterized in that: a buffer chamber is provided in the outer tank body, and a thermal insulation tank with an upper end extending outside the buffer chamber is provided in the buffer chamber; There is a buffer mechanism for reducing the impact force of the tank body. The thermal insulation tank is internally provided with an internal tank body, the internal tank body is provided with a storage cavity, and the upper end of the thermal insulation tank is provided with a control cavity. A transmission block is provided in the cavity. The transmission block is provided with a transmission cavity. The transmission cavity is threadedly connected with a downwardly extending transmission rod. A spring cavity is provided below the control cavity. A sealing mechanism for sealing the storage cavity, the sealing mechanism includes a piston block, a pressure relief block is fixed in the piston block, a pressure relief cavity is arranged in the pressure relief block, and the pressure relief cavity is provided in the pressure relief cavity. There is a pressure relief mechanism for maintaining the pressure in the tank. A tank joint is provided on the right side of the pressure relief chamber. An internal communication chamber is provided in the tank joint. A stopper is slidably arranged in the internal communication chamber. The right end of the plug is rotatably provided with a rotating rod, and the lower end of the rotating rod is rotated with the lower side wall of the inline communication cavity. Then, a cooling box is provided on the left side of the outer tank, and a cooling mechanism for cooling the storage chamber is provided in the cooling box. The cooling mechanism includes a cooling chamber provided in the cooling box. A compressor chamber is also provided in the box, and a compressor is fixed in the compressor chamber. A pump chamber is also provided in the cooling box, and a pump is fixed in the pump chamber.

2. The liquid oxygen storage tank according to claim 1, characterized in that: a joint is installed on a joint of the tank body, and a connection cavity is provided in the joint, and an internal joint is provided in the connection cavity. The inner joint is provided with an external communication cavity, the left side of the external communication cavity is provided with a material inlet and outlet cavity, the joint wall is provided with a sliding sleeve cavity, the sliding sleeve cavity is provided with a sliding sleeve, and the outside of the sliding sleeve is A slider is fixedly arranged, and a fixing ring is provided on the lower side wall of the sliding sleeve cavity, and the fixing ring is slidably connected with a fixing bead.

3. The liquid oxygen storage tank according to claim 1, wherein the buffer mechanism further comprises a buffer spring provided in the buffer chamber, and one end of the buffer spring is fixed to an inner side of the outer tank body. 4. The other end of the buffer spring is fixedly connected to the outer surface of the heat insulation tank.

4. The liquid oxygen storage tank according to claim 1, wherein the cooling mechanism further comprises a heat exchange plate disposed in the cooling cavity, and a lower side wall of the compression cavity is fixedly extended upward and downward. 5. A coolant pipe is provided, and the upper end of the coolant pipe is fixedly connected to the compressor and the lower end is connected to the heat exchange plate. A left side wall of the compression chamber is provided with a condensing pipe, and a lower end of the condensing pipe is fixedly provided. A capillary tube, the lower end of the capillary tube is connected with the heat exchange plate, a pump cavity is arranged below the cooling cavity, a pump is fixed in the pump cavity, and a right and left extension is fixed on the right wall of the pump cavity The cooling pipe extends to the right into the heat insulation tank and surrounds the inner tank from top to bottom and passes through the right wall of the cooling cavity to connect with the heat exchange plate and the pump cavity A cooling pipe extending from left to right is fixed on the left wall, and the left end of the cooling pipe is connected to the heat exchange plate.

5. The liquid oxygen storage tank according to claim 1, wherein the sealing mechanism further comprises the spring cavity, a piston spring is fixed in the spring cavity, and an upper end of the piston spring and the The upper side wall of the spring cavity is fixedly connected, and the lower end of the piston spring is fixedly connected with the upper end surface of the piston block.

6. The liquid oxygen storage tank according to claim 1, wherein the pressure relief mechanism comprises a pressure relief slider disposed in the pressure relief chamber, and a lower end of the pressure relief slider is fixedly connected and disposed. There is a pressure relief rod, a lower end of the pressure relief rod is fixedly connected with a sealing plug, the pressure relief slider is provided with a pressure relief hole, and an upper end of the pressure relief slider is fixedly connected with a pressure relief spring. The upper side wall of the pressure relief cavity is fixedly connected, a communication air guide hole is provided between the spring cavity and the pressure relief cavity, and a left side wall of the spring cavity is provided with an air outlet hole communicating with the outside.
